(19) United States
(12) Patent Application Publication
(10) Pub. No.: US 2023/0406351 A1
(43) Pub. Date: Dec. 21, 2023

(54) COMPUTATIONALLY EFFICIENT, MACHINE LEARNING-BASED APPROACH TO IDENTIFY FAILURE CASES FOR AUTONOMOUS VEHICLE VALIDATION

(71) Applicant: Applied Intuition, Inc., Mountain View, CA (US)

(72) Inventors: Yiqi Hou, San Ramon, CA (US); Justin Dion, Campbell, CA (US); Alex Groh, Detroit, MI (US); Kenny Hoang, Mountain View, CA (US); Kimberli Zhong, Dublin, CA (US)

(73) Assignee: Applied Intuition, Inc., Mountain View, CA (US)

(21) Appl. No.: 18/339,212

(22) Filed: Jun. 21, 2023

Related U.S. Application Data
(60) Provisional application No. 63/366,771, filed on Jun. 21, 2022.

(51) Int. Cl. B60W 60/00

(52) U.S. Cl. CPC B60W 60/0011; B60W 2554/4049

(57) ABSTRACT

This disclosure relates to methods and systems for vehicle simulation, testing, and validation. The method may include defining one or more test cases for a vehicle stack based on system requirements; linking the one or more test cases to one or more parameterized scenarios, where the one or more parameterized scenarios include one or more parameter permutations; and testing the vehicle stack using the one or more test cases and the one or more parameterized scenarios.

### RELATED APPLICATION

This application claims the benefit of U.S. Provisional Application No. 63/366,771, filed Jun. 21, 2022, the disclosure of which is incorporated herein by reference in its entirety.

The present disclosure generally relates to autonomous vehicle (AV) simulation, testing, and validation systems and methods.

### BACKGROUND

A simulated environment may be used to test software. For example, a simulated driving environment may be used to test software of an autonomous vehicle.

The subject matter claimed in the present disclosure is not limited to examples that solve any disadvantages or that operate only in environments such as those described above. Rather, this background is only provided to illustrate one example technology area where some examples described in the present disclosure may be practiced.

### BRIEF DESCRIPTION OF THE DRAWINGS

Examples will be described and explained with additional specificity and detail through the use of the accompanying drawings in which:

FIG. 1 illustrates an example block diagram for a machine learning-based approach to identify failure cases in accordance with an example.

FIG. 2 illustrates an example process flow for a method for a machine learning-based approach to identify failure cases in accordance with an example.

### DESCRIPTION OF EMBODIMENTS

An autonomous-vehicle software testbed may be used to test autonomous-vehicle software. The autonomous-vehicle software testbed may simulate a driving environment to test the autonomous-vehicle software (e.g., to determine how the autonomous-vehicle software would perform in various driving situations). For example, the autonomous-vehicle software testbed may simulate a three dimensional (3-D) geographical environment and provide inputs to the autonomous-vehicle software that are analogous to inputs that the autonomous-vehicle software may receive in real-world driving conditions if the autonomous-vehicle software were running on an autonomous vehicle navigating within the actual geographical environment.

Building a fleet of millions of vehicles that can safely operate in an unconstrained world is an enormous challenge because there are a near infinite number of scenarios in real-world driving. Each intersection could easily contain a million different scenarios, and it is difficult to conclude how much testing is enough to ensure safety for all road users. Safety is a vehicle selection factor for consumers today, and regulatory compliance will be required for commercial deployment of AVs. Even with regulation, consumers will still be wary about the safety of AVs. According to the poll conducted by Partners for Automated Vehicle Education (PAVE), 48% of Americans responded that they “would never get in a taxi or ride-share vehicle that was being driven autonomously.”

To confidently state that the safety of an autonomous vehicle system is validated, development teams may test and pass not only nominal scenarios but also edge case scenarios from a large parameter space describing a staggering number of combinations of parameters such as speed limits, environmental conditions (e.g., weather, daytime/nighttime), and the presence of actors (e.g., surrounding vehicles, pedestrians, objects) and their behaviors. While approaches like runtime constraints have been suggested as catch-all solutions to ensure generated scenarios adequately test the intended interaction, the reality is that there needs to be a more intelligent, computationally efficient approach to detect more failing cases.

For example, testing an entire parameter space is computationally expensive because of the combinatorial explosion of the parameter space (millions of combinations), and is not very useful because most of the combinations are boring or sometimes even unrealistic. To explore a large parameter space in simulation, then, it is possible to filter out invalid scenarios (e.g. unrealistic actor behaviors or situations where the intended interactions don't occur), and smartly select ‘interesting scenarios’ in which the AV algorithms could potentially fail (e.g. a pedestrian jumping into the street).

For disengagement and crash reports, typically, the process of understanding scenario types (recurring traffic cases) starts with examining disengagements and crash databases. For example, autonomous vehicle collision reports mandated by the California Department of Motor Vehicles (DMV) are a data source for the AV programs to understand the collision patterns. Through examination of the prior reports, development teams may gain insights such as crash distributions by features or conditions (e.g., time of day, road conditions), factors contributing to AV crashes and disengagements, and the safety performance of AV (measured by crash frequency per unit distance) relative to human drivers. These insights can then inform test scenario designs to focus the development effort.

While the analysis of real-world adverse events is helpful, it often is not enough to validate the safety of autonomous systems because the number of collisions encountered by the test vehicles is a fraction of high-risk scenarios that AVs could encounter post-production deployment.

To combat the constraints of using real-world data, a more procedural and methodical approach can be used by deriving scenarios from system requirements themselves. With this approach, validation programs with requirements for their systems define test cases for their AV stack. These requirements and test cases, once parameterized, can be linked to parameterized scenarios that sweep over many permutations of the parameters. These generated scenarios help AV system engineers to test their stacks on incredibly diverse situations, many of which may be extremely dangerous or otherwise impossible to test in the real world.

There are a variety of ways to improve on parameter sweep based requirements testing, the most straightforward of which is parameter-based pruning. Parameterized scenarios generally generate three categories of scenarios: those that are realistic and easy for the AV stack, those that are realistic and difficult, and those that are unrealistic. Parameter-based pruning allows scenario creators to exclude scenarios that they know are unrealistic, impossible, or otherwise irrelevant based on the input parameters. By using a combination of parameter sweep scenarios and pruning, AV teams can get a better understanding of their true coverage over a realistic scenario space.

A consideration for parameter-based pruning is that it may rely on scenario creators to know how scenario parameters will affect simulation properties for scenarios that are purely created by humans. Runtime constraints remedy this by allowing scenario creators to introduce constraints on the simulation properties themselves. By specifying constraints on interactions between actors and the ego during simulation time, it is possible to ignore examples that do not display specific behaviors or force those behaviors to occur.

For a scenario in which a goal is to test for avoiding aggressive actors merging on a highway, the parameter could include parameters on a highway traffic spawner and the speed or aggressiveness factor of a designated aggressive actor. In these cases, simulations that do not necessarily make sense may be pruned or adjusted. For example, where the background highway traffic and the aggressive actor collide, or where the aggressive actor hits the ego vehicle from behind. However, these observed outcomes could vary based on ego behavior and are not clearly semantically tied to the input parameters. In this case, runtime constraints may detect these failure cases early and either trigger a simulation failure or force the simulation to continue within boundary conditions.

In some instances, runtime constraints can be difficult to define in a semantically meaningful fashion. In the rear-end collision example from above, it may be easy to filter for collisions from the rear, but it may be difficult to determine if the cause is out of bounds for the test case. For instance, the rear-end collision could be caused by the ego slowing down too quickly, a variation that may be included in the test suite. However, it could also be caused by the actor merging too late, which is a failure that may be excluded. Additionally, runtime constraints can introduce some non-realism, especially while enforcing constraints.

Despite these limitations, runtime constraints can be a powerful way to semantically prune aspects of a scenario's parameter space without exactly knowing how the parameters map to simulation properties. Combined with random or probabilistic sampling methods on the input parameter space, it can greatly reduce the computation used to validate an AV stack.

To address some of the shortcomings described herein, a machine learning-based approach may be used to search for failure cases more efficiently and proactively, such as a machine learning-based approach with auto-sampling.

A machine-learning (ML) based approach can help development teams more intelligently explore the parameter space for events of interest. With this approach, normal, uninteresting cases are automatically minimized when validation teams execute simulation tests. Because a subset of combinations are run with the goal of finding interesting cases that either result in a failure or close to a failure, it can drastically reduce the amount of time and the cost of compute.

This approach works by modeling the autonomous vehicle stack as a black or grey box function mapping between a scenario's parameter space and the results of the simulation. This abstraction allows the auto-sampling mechanism to apply a variety of statistical techniques to sample the interesting edge cases.

Auto-sampling has the potential to reduce the number of searched parameters by orders of magnitude. For example, for a standard unprotected left turn scenario with an ego and two actors, thousands of combinations of initial parameters may be naively or randomly sampled in order to induce a failure. With auto-sampling, the scenario parameter response function for time to collision (TTC) can be approximated and intelligently searched for. Using this technique, it is possible to save as much as 90% of simulation costs and compute time associated with running complex parameterized scenarios, simply by focusing on the most interesting areas of the parameter space.

To further improve auto-sampling, response functions may be relatively well-behaved and fully deterministic in order for auto-sampling to be most effective. Additionally, by combining auto-sampling with parameter-based pruning and runtime constraints, it is possible to remedy any issues with different sampling techniques, different response function topographies.

Auto-sampling is a powerful tool that learns from a stack's failures, explores its weak points, and surfaces potential failure modes in a fraction of the time that it takes traditional parameterized scenarios. These techniques augment verification and validation workflows by finding and testing the 1% of failure cases rather than the 99% of cases that are easy to handle. Ultimately, auto-sampling adds a powerful tool to a verification and validation toolbox.

Exploratory validation that proactively searches for potential failure cases may be used complement existing validation workflows. The disclosed validation and verification management systems may support AV development teams with detecting failure cases early and mitigating risks of costly, unsafe events from occurring in the real world.

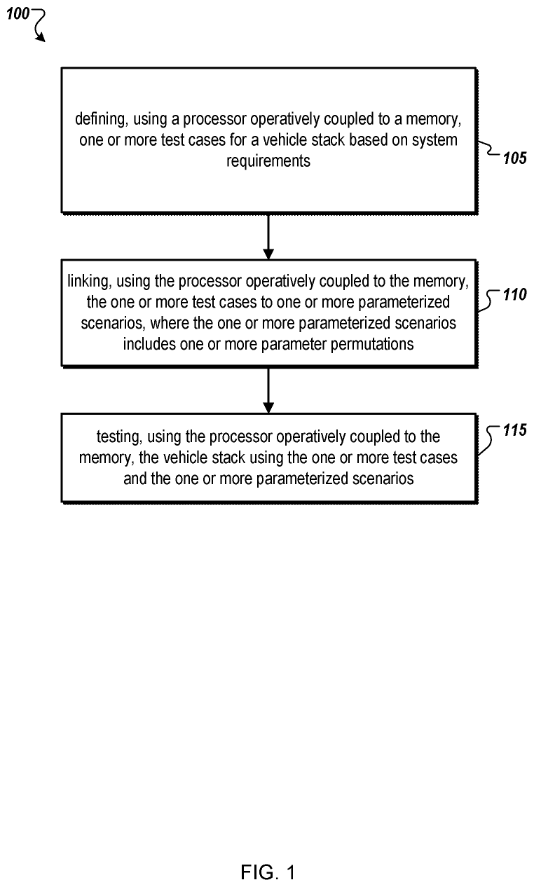

FIG. 1 illustrates a process flow of an example method 100 that may be used for vehicle testing, simulation, or validation, in accordance with at least one example described in the present disclosure. The method 100 may be arranged in accordance with at least one example described in the present disclosure.

The method 100 may be performed by processing logic that may include hardware (circuitry, dedicated logic, etc.), software (such as is run on a computer system or a dedicated machine), or a combination of both, which processing logic may be included in a processor, or another device, combination of devices, or systems.

The method 100 may begin at block 105 where the processing logic may be configured to define one or more test cases for a vehicle stack based on system requirements.

At block 110, the processing logic may be configured to link the one or more test cases to one or more parameterized scenarios, where the one or more parameterized scenarios include one or more parameter permutations.

At block 115, the processing logic may be configured to test the vehicle stack using the one or more test cases and the one or more parameterized scenarios.

Modifications, additions, or omissions may be made to the method 100 without departing from the scope of the present disclosure. For example, in some examples, the method 100 may include any number of other components that may not be explicitly illustrated or described.

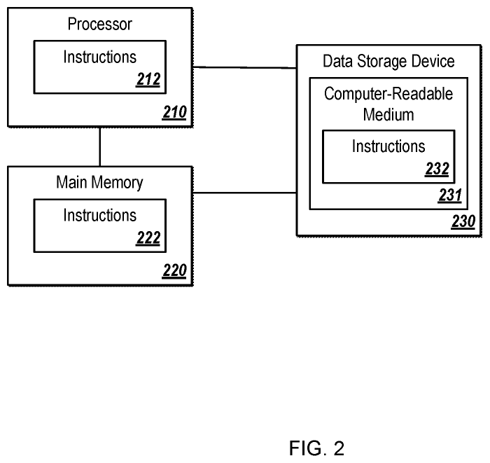

In some examples, as illustrated in FIG. 2, an AV simulation, testing, and validation system may include an environmental representation-creation module that may include code and routines configured to enable a computing device to perform one or more operations with respect to generating a 3-D environmental representation, generating scenarios, pruning, auto-sampling, etc. Additionally or alternatively, the environmental representation-creation module may be implemented using hardware including a processor 210 (configured to execute instructions 212), a microprocessor (e.g., to perform or control performance of one or more operations), a field-programmable gate array (FPGA), or an application-specific integrated circuit (ASIC). In some other instances, the environmental representation-creation module may be implemented using a combination of hardware and software. In the present disclosure, operations described as being performed by the environmental representation-creation module may include operations that the environmental representation-creation module may direct a corresponding system to perform.

In some examples, the environmental representation-creation module may be configured to generate the 3-D environmental representation. The environmental representation-creation module may generate the 3-D environmental representation according to any suitable 3-D modeling technique. In some examples, the environmental representation-creation module may use map data as input data in the generation of the 3-D environmental representation. For example, the 3-D environment of the 3-D environmental representation may represent the geographic area represented by the map data.

In some examples, the 3-D environmental representation may include a 3-D model of one or more objects in the geographic area as described by the filtered map data. For example, the 3-D environmental representation may include a complete 3-D model of the simulated driving environment.

The AV simulation, testing, and validation system may include machine learning circuitry and/or software to identify failure cases more efficiently and proactively. The AV simulation, testing, and validation system may include circuitry and/or software for pruning, including parameter-based pruning. The AV simulation, testing, and validation system may include circuitry and/or software to implement runtime constraints on a scenario, simulation, or within a 3-D environmental representation.

A computing system may be used for the techniques described herein, according to at least one example of the present disclosure. The computing system may be configured to implement or direct one or more operations associated with any one of the modules and/or operations discussed in the present disclosure. The computing system may include a processor 210, a memory (e.g., a main memory 220 including instructions 222), and a data storage (e.g., a data storage device 230 including a transitory or non-transitory computer-readable medium 231 including instructions 232)). The processor 210, the memory (e.g., a main memory 220), and the data storage may be communicatively coupled.

In general, the processor 210 may include any suitable computer, computing entity, or processing device including various computer hardware or software modules and may be configured to execute instructions stored on any applicable computer-readable storage media. For example, the processor 210 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The processor 210 may include any number of processors 210 configured to, individually or collectively, perform or direct performance of any number of operations described in the present disclosure. Additionally, one or more of the s may be present on one or more different electronic devices, such as different servers.

In some examples, the processor 210 may be configured to interpret and/or execute program instructions and/or process data stored in the memory (e.g., a main memory 220), the data storage (e.g., a data storage device 230), or the memory (e.g., a main memory 220) and the data storage (e.g., a data storage device 230). In some examples, the processor 210 may fetch program instructions from the data storage (e.g., a data storage device 230) and load the program instructions in the memory (e.g., a main memory 220). After the program instructions are loaded into memory (e.g., a main memory 220), the processor 210 may execute the program instructions.

For example, in some examples, one or more of the above mentioned modules may be included in the data storage (e.g., a data storage device 230) as program instructions. The processor 210 may fetch the program instructions of a corresponding module from the data storage (e.g., a data storage device 230) and may load the program instructions of the corresponding module in the memory (e.g., a main memory 220). After the program instructions of the corresponding module are loaded into memory (e.g., a main memory 220), the processor 210 may execute the program instructions such that the computing system may implement the operations associated with the corresponding module as directed by the instructions.

The memory (e.g., a main memory 220) and the data storage (e.g., a data storage device 230) may include computer-readable storage media for carrying or having computer-executable instructions or data structures stored thereon. Such computer-readable storage media may include any available media that may be accessed by a general-purpose or special-purpose computer, such as the processor 210. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 210 to perform a certain operation or group of operations.

Modifications, additions, or omissions may be made to the computing system without departing from the scope of the present disclosure. For example, in some examples, the computing system may include any number of other components that may not be explicitly illustrated or described.

As indicated above, the examples described in the present disclosure may include the use of a computer including various computer hardware or software modules, as discussed in greater detail below. Further, as indicated above, examples described in the present disclosure may be implemented using computer-readable media for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although examples of the present disclosure have been described in detail, various changes, substitutions, and alterations could be made hereto without departing from the spirit and scope of the present disclosure.

What is claimed is:

1. A method, comprising:
defining, using a processor operatively coupled to a memory, one or more test cases for a vehicle stack based on system requirements;
linking, using the processor operatively coupled to the memory, the one or more test cases to one or more parameterized scenarios, wherein the one or more parameterized scenarios comprise a plurality of parameter permutations; and
testing, using the processor operatively coupled to the memory, the vehicle stack using the one or more test cases and the one or more parameterized scenarios.

2. The method of claim 1, further comprising:
pruning, using the processor operatively coupled to the memory, at least one scenario of the one or more parameterized scenarios based on one or more of a set of possible scenarios or a set of relevant scenarios.

3. The method of claim 1, further comprising:
filtering, using the processor operatively coupled to the memory, at least one invalid scenario out of the one or more parameterized scenarios.

4. The method of claim 1, further comprising:
identifying, using the processor operatively coupled to the memory, at least one scenario of the one or more parameterized scenarios based on a likelihood of failure.

5. The method of claim 1, further comprising:
selecting, using the processor operatively coupled to the memory, at least one scenario of the one or more parameterized scenarios based on a likelihood of failure to test the vehicle stack.

6. The method of claim 1, further comprising:
determining, using the processor operatively coupled to the memory, a test coverage over a realistic scenario space.

7. The method of claim 1, wherein the vehicle is an autonomous vehicle.

8. The method of claim 1, wherein the vehicle stack is an autonomous vehicle stack.

9. A system, comprising:
a memory; and
a processor operatively coupled to the memory, the processing being configured to execute instructions to cause the system to:
generate a simulation environment for testing or validating a vehicle, wherein when generating the simulation environment, the processor is configured to perform at least one of:
impose a runtime constraint on simulation properties of the simulation environment.

10. The system of claim 9, wherein the simulation properties include one or more interactions between one or more actors and one or more ego vehicles.

11. The system of claim 9, wherein the processor is further configured to execute instructions to cause the system to:
detect a failure scenario using the runtime constraint.

12. The system of claim 9, wherein the processor is further configured to execute instructions to cause the system to:
trigger a simulation failure based on detecting a failure scenario using the runtime constraint.

13. The system of claim 9, wherein the processor is further configured to execute instructions to cause the system to:
continue a simulation within one or more boundary conditions based on detecting a failure scenario using the runtime constraint.

14. The system of claim 9, wherein the processor is further configured to execute instructions to cause the system to:
impose the runtime constraint without using a mapping between the simulation properties and a scenario parameter space.

15. A system, comprising:
a memory; and
a processor operatively coupled to the memory, the processing being configured to execute instructions to cause the system to:
generate a simulation environment for testing or validating an autonomous vehicle, wherein when generating the simulation environment, the processor is configured to perform at least one of:
use machine-learning to sample a subset of scenarios from a group of possible scenarios to test.

16. The system of claim 15, wherein the processor is further configured to execute instructions to cause the system to:
select the subset of scenarios using auto-sampling to minimize a number of non-edge scenarios.

17. The system of claim 15, wherein the processor is further configured to execute instructions to cause the system to:
generate a model mapping a scenario parameter space and one or more simulation results to identify the subset of scenarios to sample.

18. The system of claim 15, wherein the processor is further configured to execute instructions to cause the system to:
search for a scenario parameter response function using auto-sampling.

19. The system of claim 15, wherein the processor is further configured to execute instructions to cause the system to:
select the subset of scenarios using auto-sampling to reduce a computation time.

20. The system of claim 15, wherein the processor is further configured to execute instructions to cause the system to:
adjust one or more of a verification workflow or validation workflow
